(19) United States
(12) Patent Application Publication
(10) Pub. No.: US 2014/0236759 A1
(43) Pub. Date: Aug. 21, 2014

(54) Wellness System and Methods

(71) Applicant: Christopher Mirabile, West Palm Beach, FL (US)

(72) Inventor: Christopher Mirabile, West Palm Beach, FL (US)

(21) Appl. No.: 14/162,860

(22) Filed: Jan. 24, 2014

Related U.S. Application Data
(60) Provisional application No. 61/756,185, filed on Jan. 24, 2013.

(51) Int. Cl. G06Q 30/06

(52) U.S. Cl. CPC G06Q 30/0633
USPC 705/26.8

(57) ABSTRACT

Processes, methods and systems for pairing a person with food and/or wellness opportunities utilize a personal information inventory and a database to determine selections and to deliver food to the person. Computer systems process and carry out methods for providing a person with custom-tailored food and/or wellness opportunities by analyzing and categorizing personal information, determining delivery locations, determining food providers, and assembling lists of available food options for the person. Food can be delivered or made available to the person based upon the analysis.

### CROSS-REFERENCE TO RELATED APPLICATIONS

This application claims priority to U.S. Provisional Patent Application No. 61/756,185, which was filed on Jan. 24, 2013, the contents of which are incorporated by reference in their entirety.

### BACKGROUND

People have been eating and engaging in wellness activities since the beginning of human existence. Throughout history, a variety of advances have been made that facilitate a person's access to food. Early advances include hunting, gathering, and agriculture. Recent advances include food delivery services, which have allowed people to order and receive food without leaving their location and without disrupting their ongoing activities.

Traditional Food Delivery requires the person needing food to invest considerable time and energy when engaging in the process of finding and ordering Food. The person must contemporaneously compile all available options, decide between them, and then order Food. A variety of tools exist for facilitating some aspects of this process.

Some online tools allow a person to place food orders by using a computer connected to the internet. Some of those online tools also save a person's ordering history for a particular food provider, lessening the need for repeatedly communicating delivery location and payment information.

In terms of categorizing meals based on certain dietary preferences, some cookbooks provide compilations of meals falling within particular meal category preferences. For example, vegan cookbooks provide collections of vegan meals. Paleo Diet cookbooks provide collections of meals falling within the principles of the Paleo Diet. Like most content, these cookbooks are available for online access with computer devices connected to the internet. Similarly, various online (aka web-based) tools allow users to search for recipes having certain specifications, such as vegetarian, vegan, low calorie, low carbohydrate, customers reviews, etc. Such tools are excellent resources for people willing to invest the time and energy required to research food options falling within particular categories.

People aiming to attain meals often search for Food providers in a certain geographic area. Searching of food based on geographic information can be accomplished with a traditional Yellow Pages phonebook or with a variety of online search engine tools. For example, a person could use the search engine “Google” to provide restaurants of a particular cuisine within a certain geographical area.

Despite the available Food fulfillment technology, there is an unmet need for using Personal Information for automatically providing a person with satisfactory Food options for a specific time and place. There is an unmet need for using Personal Information for automatically providing a person with satisfactory Food at a specific time and place. No system exists for automating food ordering on behalf of a person, based on that person's location, schedule, food preferences, and/or dietary requirements.

The closest Food fulfillment options require a user to engage in an inefficient, cognitively taxing, multi-step search process: Searching for acceptable Food options, deciding which Food to order, then manually placing the order.

Additionally, instead of using a person's real-time physical positioning data to guide that person's selection of food, these systems require the user to input delivery coordinates and/or screen search results for those meeting particular geographic criteria. Lessening the input requirements, for example by automatically acquiring or storing frequently-used geographic coordinates, would make attaining food easier.

Additionally, no system exists for automatically using a person's wellness goals to guide selection of food. Today, a person has more food choices than ever before, making it difficult to choose meals that adhere to particular life goals, such as loosing weight, or adjusting the amount of certain nutritional components (e.g., cholesterol, salt, carbohydrates, fat, etc.). In order to select foods meeting a person's goals, that person must search for available food options, then consider the relative merits of each option based on that person's goals. There exists a need for systems and methods, which automate this process, considering more available options while also lessening time investment needed from the person.

With the advent of wireless technology, a variety of body monitoring tools are now capable of measuring and transmitting physical data about a person contemporaneously. For example, wearable devices can track a person's activity level, type and exertion; heart rate; blood pressure; body temperature; blood levels; sleep cycles; footsteps; etc. Such devices can seamlessly transmit this information to a computer or database via wireless transmission. However, no system or method exists for using this real-time physical data to guide the person's selection of food. Moreover, no system or method exists for using a combination of real-time physical data in concert with that person's expressed preferences and wellness goals to guide the selection of a person's food.

A similar void exists in the wellness opportunity space. There is no system or method of using Personal Information for automatically providing a person with a wellness opportunity (e.g., an exercise class, available gym, yoga class, meditation session, time spent in natural sunlight, breathing exercises, listening to a specific type of music or sound, such as binaural beats, time in isolation, or nature, time with friends, learning a new skill, using a program, test or application; etc.) scheduled for a specific time and place.

The above described unmet needs correlate with many serious Diet and Wellness Compliance Problems. Because a person must invest considerable time and mental effort searching for and deliberating amongst an increasing number of Diet and Wellness opportunities, compliance becomes a growing problem. A person needing Food would often succumb to accepting easily attainable food in order to eliminate the need for compiling and considering all available food options.

Similarly, a person often forgoes engaging in wellness activities on account of having too many options and/or poorly suited options. Accordingly, an ongoing need exists for compiling available wellness opportunities, evaluating their goodness of fit for a particular person at a particular time, and then suggesting those available activities to the person.

### BRIEF DESCRIPTION OF DRAWINGS

FIG. 1 shows an exemplary system and method of the disclosed invention.

FIG. 2 shows an exemplary system and method of the disclosed invention.

FIG. 3 shows an exemplary system and method of the disclosed invention.

### DETAILED DESCRIPTION

Better processes, methods and systems for pairing a person with food and or wellness opportunities have now been invented. Disclosed herein are processes, systems, and methods for providing a person with custom-tailored food and/or wellness opportunities.

Disclosed herein is a computer-implemented process for providing a person with Food. In one embodiment, the computer-implemented process for providing a person with Food comprises Acquiring Personal Information about the person, storing it, and using that information to provide Food to the person. In one embodiment, the computer-implemented process for providing a person with Food comprises Acquiring Personal Information about the person, storing it, and using that information automatically deliver Food to the person. In one embodiment automatically delivering Food to the person includes physically delivering Food to the person. In another embodiment, automatically delivering Food to the person includes delivering available options to the person in an organized, readable form, ready for fulfillment.

In another embodiment, the method comprises Acquiring Personal Information about the person and using that information to present the user with recommendations for Food. In one embodiment of the method, the person may opt-in or opt-out of delivery of the Food. In one embodiment, the Personal information is real-time information about a specific person, including recent caloric intake, activity level, or physiological data. In another embodiment, Personal Information is information about a person's mental state, such as mood.

Disclosed herein is a computer-implemented process for providing a person with Food, comprising:

Acquiring Personal Information about the person;

Determining the Delivery Location for the Food;

Searching a Global Database of Food Providers;

Determining Viable Food Providers;

Assembling a List of Available Food;

Cross-Referencing the List of Available Food with the Personal Information about the person; and

Compiling a List of Viable Food Options.

In one embodiment, the disclosed method stores all of a person's submitted data; cross-references this data with a stored database of restaurants and associated meals; identifies restaurants and meals that fulfill person's schedule, including the possibility for delivery to geographic location and during date and time of day, and determines which meals best satisfy the person's specified meal requirements and preferences. In one embodiment a list of Viable Food Options is compiled. In another embodiment, a particular meal is automatically delivered to the person. In another embodiment, a particular meal is delivered to the person according to a predefined schedule. In another embodiment, a person is presented with an opt-in confirmation option for a meal. In another embodiment, a person is presented with an opt-out alert for preventing fulfillment of an otherwise automatically delivered or fulfilled meal.

As used herein, the term “Food” means any matter safe for ingesting. Within this disclosure “matter” means anything having mass. Within this disclosure, the term Food includes any mass covered under the United States Food and Drug Administration's definition of Food in addition to supplements. Food can include anything safe for introducing into the gastrointestinal tract or human bloodstream (e.g., by transdermal means), whether it has caloric content or not. In one embodiment Food comprises mass chosen from protein, carbohydrate, and fat. In another embodiment Food comprises plant matter. In another embodiment Food comprises animal matter. In another embodiment Food comprises vitamins or minerals. In another embodiment, Food comprises nutritional supplements. In one embodiment Food comprises water. In another embodiment Food comprises beverages.

As used herein, the term “providing a person with Food” means making the Food available to the person. In one embodiment “providing a person with Food” means physically connecting a person with Food, for example by moving the Food to the precise geographical coordinates of the person so that the Food is within reach of the person. In another embodiment, “providing a person with Food” means presenting the person with an immediately realizable option for physically connecting with the Food, for example by making food available by acting through a user input device. In one embodiment, after receiving the presented Food option, the person may opt-in or opt-out of having the Food delivered.

The term “providing a person with Food” includes conventional food delivery services. The term “providing a person with Food” also includes presenting the user with an immediately attainable automated delivery of Food. In one embodiment, providing a person with Food comprises orchestrating the transport of Food from a restaurant to a specified address, for example an address previously defined by the person or an address identified by a GPS or location tracking device. In one embodiment, providing a person with Food comprises orchestrating the transport of Food from a market or grocery store to a person. In one embodiment, providing a person with Food comprises presenting the person with a digital means for confirming an order. In one embodiment, providing a person with Food comprises one-click order confirmation or fulfillment. In another embodiment, the person Food may be automatically delivered to the person. In one embodiment, automatic delivery is subject to an opt-out mechanism. In one embodiment, automatic delivery is subject to either or both of a user selection process or an opt-in mechanism. Such a user selection process includes a person selecting one specific meal for delivery from a larger set of options.

In one embodiment, Compiling a List of Viable Food Options is accomplished by weighting factors that include, but are not limited to a person's custom schedule of meals, random selection, reviews of meals, a recommender engine, and frequency of and time since a particular meal order. In one embodiment, the person can elect to manually select or approve of which meal to order per instance, or automate the ordering according to the specified logic.

As used herein, “Acquiring” means getting or gathering. “Acquiring Personal Information” means gathering Personal Information. Acquiring Personal Information may be accomplished by a variety of means and using any technology known in the art.

In one embodiment, Personal Information is inputted into the disclosed systems and methods via means, including but not limited to manual entry via electronic forms, manual upload of data (i.e., a CSV of genetic data), seamless integration via third parties' Application Programming Interface (API) for synchronization with the said systems and methods.

In one embodiment, Personal Information is acquired by quantified self technologies (real-time and historical inputs [e.g. food consumed, quality of surrounding air, blood levels, skin temperature, etc.], states [e.g. mood, arousal, blood oxygen levels], and performance [mental and physical]).

In one embodiment Acquiring Personal Information includes having the person manually enter information into a database, for example by using a traditional computer interface, such as a keyboard, mouse, voice recognition software, mobile device, etc. In one embodiment Acquiring Personal Information includes collecting data from a body-monitoring device, such as a heart rate monitor, pedometer, or other wearable, non-wearable or implantable measuring device. Such devices are commercially available in a variety of forms as either stand-alone personal devices or components of other equipment, such as exercise equipment. It should be understood by a person in the art, that known measuring devices can be coupled with a transmission means to supply the measured data to a Database of Personal information.

In one embodiment Acquiring Personal Information includes collecting data from a set of Life caching data. Life caching (aka life logging, lifeblogging, or lifeglogging, self-monitoring and/or self-sensing) refers to an act of storing and sharing one's life events, including physical data and subjective or mood data. In some circumstances, modern life caching is considered a form of social networking and typically takes place on the internet. Such life caching often combines wearable sensors (EEG, ECG, video, etc.) and wearable computing. Other names for using self-tracking data to improve daily functioning are “self-tracking”, “auto-analytics”, “body hacking” and “self-quantifying”.

In one embodiment, Acquiring Personal Information includes collecting survey data from a specific person, including, for example, questions about the person's body, activity, Goals, food allergies, Preferences, or other categories of information that may be deemed relevant to making Food choices by the person or accepted dietary wisdom. Survey data may be acquired through a variety of platforms including manually inputting the survey data into a computer database or using a computer survey platforms to receive and store the survey data.

In one embodiment, Personal Information includes a person's scheduling preferences, including day(s) of week, time(s) of day and physical address(es) for restaurant selection and food delivery. As defined herein, “schedule” may be includes either events expressly planed and calendared by a person or dictated by an event (i.e., Food suggestion after Activity, e.g., Drink 16 oz of water+salt after running 4.5 miles).

As used herein, “Personal Information” is information about a human being. For any given human being, categories of Personal Information include physical attributes, for example, sex, age, height, current weight, body mass index (“BMI”), body measurements (e.g., waist, bust, arm, chest, etc.). Personal information also includes date of birth, weight, body fat percentage, sex, race or ethnicity, living & work conditions, ZIP code, size of home and/or workplace, time spent outdoors, time spent under natural sunlight, occupation, time spent sitting vs. standing, time spent watching television or in front of a computer, medical history and current medical conditions and ailments (e.g., diabetes, cancer [including type and status], ADHD, depression, obesity, heart disease, physical injury, low libido/sex drive, etc.), cholesterol levels (e.g., total cholesterol, LDL cholesterol, HDL cholesterol, triglycerides, ApoA1, ApoB, LP(a), Lp-PLA2, Omega-3 Fatty Acids, Free Fatty Acids, etc.), liver & kidney health (e.g., BUN/Creatinine, AST & ALT, Total Bilirubin, Albumin, Total Protein, etc.), performance hormones (e.g., DHEA, Free Testosterone, Testosterone, Estradiol, SHBG, etc.), metabolic hormones, (e.g., cortisol, IGF-1, insulin), thyroid & blood sugar (e.g., glucose, HbA1c, etc.), advanced thyroid (e.g., Total T4, T3 uptake, free T4 index, TSH, total T3, free T3, reverse T3, free T4, etc.), advanced Inflammation (e.g., hs-CRP, fibrinogen, homocysteine, etc.), blood count and advanced nutrients (e.g., complete blood count with differential, calcium, electrolytes, bicarbonate, ferritin [serum], total Iron binding capacity [TIBC], folate, vitamin B12, RBC Magnesium, 25-Hydroxy vitamin D, etc.), womens' reproductive panel (e.g., progesterone, FSH, Luteinizing Hormone, etc.), blood pressure (diastolic, systolic), food allergens, food sensitivities, hormone levels (via blood, urine and/or saliva tests), assessment of physical/athletic health (i.e., recent physical activity, upload of heart rate/activity information, etc.), resting heart rate, active heart rate and Heart Rate Variability during specific activities (i.e., while working, while walking “x” mph for “y” minutes, etc.), VO2 max, genetic testing—DNA sequencing, neural waves (e.g., EEG, HEG and other readings), sleep effectiveness (total time, time per sleep stage, number of sleep stages, etc.), physical activity (type of activity[ies], duration, and any quantified self outputs (heart rate, skin temperature, horizontal and vertical distance, weight of self and equipment, repetitions, etc.).

As used herein, “Personal Information” also includes lifestyle data, such as activity level, activity type (resistance training, aerobic training, intensity, medication, etc.), occupation, sleep, family history, medical records, blood levels, drug use, historical eating patterns, historical meal ingredients, mood, feedback about meal history.

As used herein, the term “Personal Information about the person” means data about a specific human being. A specific human being may be cataloged by name, number, or other unique record locator.

As used herein, “Delivery Location for the Food” means the geographic coordinates to which the Food is physically transferred. In one embodiment, “Delivery Location for the Food” means a street address. In another embodiment, “Delivery Location for the Food” is the site where the Food is prepared, for example, where a person goes to the location of preparation to receive the Food.

As used herein, the term “Determining the Delivery Location for the Food” means identifying the geographic coordinates to which the Food must be physically transferred. In one embodiment, “Determining the Delivery Location for the Food” includes using GPS data or other services which transmit location data. In one embodiment, “Determining the Delivery Location for the Food” includes requesting input from the person to whom Food is being delivered, for example via email, text message, or other electronically communicated means. In one embodiment, “Determining the Delivery Location for the Food” includes referring to a schedule of meals previously defined by the user, for example: delivery to a particular location at particular time, and at an alternative location at another time and location.

As used herein, “Determining Viable Food Providers” means filtering a set of all available Food Providers to arrive at a set of options available to the user at the needed time and place. In one embodiment, “Determining Viable Food Providers” includes winnowing down a set of all available Food Providers to eliminate Food Providers not offering meals at the time needed by the person. In one embodiment, “Determining Viable Food Providers” includes winnowing down a set of all available Food Providers to eliminate Food Providers not offering meals delivered to the location required by the person. In one embodiment, “Determining Viable Food Providers” includes winnowing down a set of all available Food Providers to eliminate Food Providers not offering meals meeting the person's delivery specification. The person's “delivery specification” includes time of day and location.

In one embodiment, “Determining Viable Food Providers” includes winnowing down a set of all available Food Providers to eliminate Food Providers having a minimum order size greater than the person's order. In one embodiment, “Determining Viable Food Providers” includes winnowing down a set of all available Food Providers to eliminate Food Providers not offering Food congruent with the person's Goals. In one embodiment, “Determining Viable Food Providers” includes winnowing down a set of all available Food Providers to eliminate Food Providers not offering meals meeting the person's pricing specifications.

As used herein, “Assembling” means collecting and organizing, for example, collecting and organizing information into a useful form.

As used herein, “Available Food” means Food that could be delivered to the person and according to the person's Requirements. For example, Available Food includes Food coming from open vendors within a reasonable distance from the person.

As used herein, “Assembling a List of Available Food” means consecutively printing a selection, typically one below the other and/or beside one another, of Food that could be fulfilled to the person at their specified location and time.

As used herein, the term “Cross-Referencing the List of Available Food with the Personal Information about the person” means comparing the List of Available Food to the Personal Information about the person, thereby arriving at one or more subsets of Food, depending on whether attributes of the Available Food correlate with relevant Personal Information, such as a person's Preferences, Goals, or Requirements.

As used herein, “Compiling” means producing something, e.g., a list, report, or book) by assembling information collected from other sources.

As used herein, “Viable Food Options” means meals best satisfying a person's Preferences, Requirements, and/or Goals. In one embodiment, Viable Food Options are complied by weighing the relative merits of each member of the List of Available Food and selecting those Food options best meeting the person's Preferences, Requirements, and/or Goals. A variety of decision engines, used for weighing the relative merits of collections of preferences, are known in the art.

Preferences, Requirements, and/or Goals may include any criteria specified by the person, for example physical location for delivery, date(s)/day(s) of week, time(s), or automatic (sent or recommended to user when system determines the best time is, via email, mobile application, automatic delivery, integrated physiological device, etc.), calories, macronutrient quantities and/or ratios, e.g., Fat and type thereof (Medium Chain Triglycerides, Long Chain Fatty Acids, Omega-3 [EPA, DHA], Omega-6, etc.), Carbohydrates (fructose, sucrose, glucose, soluble fiber, insoluble fiber, starch, sugar alcohols [zylitol, erythritol, inositol, etc.], etc.), Protein (whey, soy, egg, casein, etc.), Ethanol (red wine, etc.), Micronutrient presence and quantity (iron, cobalt, chromium, copper, iodine, manganese, selenium, zinc, molybdenum, vitamins, etc.), dietary mineral presence and quantity (calcium, phosphorus, potassium, sulfur, sodium, chlorine, magnesium, boron, chromium, sulfur, etc.), Presence of chemicals or other substances (e.g., pesticides, growth hormones, etc.), Preparation method (raw, baked, stir-fried, deep fried, etc.), cooking temperature and duration, Specific ingredients (white list & black list), Source or origin of ingredients, Form of agriculture, e.g., organic farming, permaculture, industrial agriculture, etc., GMO vs. non-GMO, Cuisine, particular vendors (restaurant, grocery supplier, supplement supplier, etc.), historical ratings of recommendation (user's own ratings & other people's ratings, [i.e., only meals rated above 3 out of 5 stars on a particular review website, or only supplements with an effectiveness rating above 75%]), safety score (supplement/medication related; authoritative source and/or aggregate user/community feedback).

As used herein, “Compiling a List of Viable Food Options” means producing a collection of meal options meeting a person's Preferences and Requirements. In one embodiment, “Compiling a List of Viable Food Options” includes prioritizing and/or assigning a confidence value to said Viable Food Options. In one embodiment, “Compiling a List of Viable Food Options” includes applying a logic for selecting which meals to present to the person, in which order, as well as how to present that info. For example, in one embodiment, “Compiling a List of Viable Food Options” includes ranking a plurality of available meals available based on the goodness of fit with the person's stated Goals. In one embodiment, “Compiling a List of Viable Food Options” includes selecting for meals providing a variety (e.g., varying cuisines, restaurants, etc.) of different Food to the person over a defined period of time. The List of Viable Food Options may not satisfy all Preferences or Goals; rather the List of Viable Food Options includes good options for Food. In one embodiment, the List of Viable Food options includes a ranked list of Food providing the best fit for a person's Preferences, Requirements, and Goals.

In one embodiment, the process for providing a person with Food comprises delivering Food to the person at the Delivery Location. In another embodiment, providing a person with Food comprises making the Food available at a particular local restaurant, grocery store, or retailer.

As used herein, “Delivery Location” means the geographic coordinates where Food is scheduled for delivery and/or physically delivered.

In one embodiment, the process comprises filtering the List of Available Food to select for meals meeting the person's Preferences.

As used herein, “filtering the List of Available Food” means screening the List of Available Food to identify a subset of Food items. In one embodiment, “filtering the List of Available Food to select for meals meeting the person's Preferences” means screening the List of Available Food to identify a set of Food that adheres to the Preferences either explicitly specified by the person or inferred based on the person's Goals and/or recent activity.

In one embodiment, Goal based inferences include simple If-Then statements that correlate goals with accepted health and wellness principles. For example, where the person specifies a Goal of losing weight, the inferred logic would filter Food choices to prefer meals offering fewer calories than burned by the person during the period. Other If-Then statements may also be applied to a single Goal, for example, for the Goal of losing weight, in addition to caloric restriction, another filter may consider macronutrient types (minimize sugar, maximize fiber). In one embodiment, multiple If-Then statements are combined to arrive at a more complicated algorithm based on the person's Personal Information.

In one embodiment, the process comprises filtering the List of Available Food to exclude meals failing to meet the person's Requirements. In one embodiment, the act of excluding meals “failing to met the person's requirements” involves removing meals not satisfying the person's Requirements from the List of Available Food

In one embodiment, the process comprises filtering the List of Available Food to exclude meals incongruent with the person's Goals. In another embodiment, the process comprises filtering the List of Available food to discriminate against Food incongruent with the person's Goals.

As used herein, the term “incongruent with the person's Goals” means not in agreement with the person's goals.

In one embodiment, filtering the List of Available Food to exclude meals incongruent with the person's Goals includes correlating the person's Goals with certain types of Food and then excluding items on the List of Available Food where those items do not fall within the said certain types of Food. In another embodiment, filtering the List of Available Food to exclude meals incongruent with the person's Goals includes correlating the person's Goals with certain types of Food and then discriminating against items on the List of Available Food where those items do not fall within the said certain types of Food.

In one embodiment, the process for providing a person with Food comprises acquiring Personal Information about the person less than 3 hours before Compiling the said List of Viable Food Options to the person. In one embodiment, the process for providing a person with Food comprises acquiring Personal Information about the person less than 2 hours before Compiling the said List of Viable Food Options to the person. In one embodiment, the process for providing a person with Food comprises acquiring Personal Information about the person less than 1 hour before Compiling the said List of Viable Food Options to the person. It should be understand that the term “less than” a specified period of time would include a virtually instantaneous period of time.

In one embodiment, the process comprises automatically delivering Food to the person.

As used herein the term “automatically” means occurring via self-acting mechanism. One tremendous benefit of the disclosed systems and methods is increasing compliance with wellness programs and advice. Automating the Food delivery and automatically selecting meals meeting person's Goals, Preferences, and Requirements increases the likelihood of a person complying with a beneficial diet and wellness program by making it easier for the person to connect with Food or wellness activities.

Within the context of this disclosure, “automatically,” includes multiple methods of selection. For example, auto-ordering and auto-delivery as well as manual order execution and/or meal selection. In one embodiment, the term “automatically” includes automatic methods having an opt-in and/or opt-out step.

As used herein, the term “automatically delivering Food to the person” means delivering Food to the person via a self-acting mechanism.

In one embodiment, the process for providing a person with Food comprises providing Food chosen from plants, animals, beverages, restaurant meals, grocery store items, or nutritional supplements.

As used herein, the term plants means multicellular organisms of the kingdom Plantae.

As used herein, the term “animals” means multicellular, eukaryotic organisms of the kingdom Animalia or Metazoa.

As used herein, the term “beverage” means any one of various liquids for drinking, usually comprising water as one of the liquids.

As used herein, the term “restaurant meals” means food originating from and prepared in a restaurant.

As used herein, the term “grocery store items” means items purchased from a grocery store, often unprepared, such as fresh produce or ingredients. It should be understood that the term “grocery store items” does not require that the said item originate from a grocery store but rather could be provided by a produce fulfillment service tasked with delivering such items.

As used herein, the term “nutritional supplements” means matter intended to provide nutrients that may otherwise not be consumed in sufficient quantities. Such nutritional supplements may or may not include caloric value. Supplements are generally understood include vitamins, minerals, fiber, fatty acids, or amino acids, among other substances. In some cases, U.S. authorities define dietary supplements as foods, while elsewhere they may be classified as drugs or other products. Within this disclosure the term “nutritional supplements” includes herbal remedies or other holistic natural products whether the health benefits are verified by science of not.

In one embodiment, the process comprises Determining the Delivery Location for the Food by acquiring the person's physical location via GPS data or physical tracking device.

As used herein the term “GPS” means Global Positioning System, which refers to a space-based satellite navigation system that provides location and time information.

As used herein, the term “physical tracking device” means a device used to determine the physical location of the target, whether by satellite (e.g., GPS), triangulation, or any other means for providing location based data. In one embodiment, the “target” may be a person's electronic mobile device, such as a phone.

In one embodiment, the process comprises automatically choosing a specific meal from the List of Viable Food Options.

As used herein, the term “choosing a specific meal from the List of Viable Food Options” means selecting one of the predetermined combinations of Food.

Disclosed herein is a method of providing real-time health and wellness advice comprising:

Collecting Realtime Physical Data about a specific user;

Compiling List of Available Wellness Options;

Applying Specific User Defined Logic; and

Presenting the user with Real-time Viable Wellness Options.

As used herein, the term “Collecting” means acquiring and accumulating items to store over a period of time. The acquired or accumulated items include data or other information stored via analog or digital means. In one embodiment, Real-time Physical Data about a specific user is stored in a cloud-based database.

As used herein, the term “Real-time Physical Data” means recent or current information related to the state of the body.

As used herein, the term “specific user” means a determined and identified individual who has elected to participate in use of the Food and/or Wellness service or tool.

As used herein, the term “Collecting Real-time Physical Data about a specific user” means acquiring and accumulating recent or current data pertaining to the state of the body of a determined and identified individual who has elected to participate in use of the service.

In one embodiment, the method comprises Real-time Physical Data chosen from caloric intake, body temperature, heart rate, activity level, blood pressure, sleep quality, sleep duration, and hormone levels. In one embodiment, Realtime Physical Data comprises data chosen from the above-described Personal Information.

As used herein, “caloric intake” means the amount of calories (units of food energy) taken in to the body, usually by eating.

As used herein, “body temperature” means the level of heat produced and sustained by the body processes, i.e., the temperature of the person's body.

As used herein, “heart rate” means the number of heart beats per unit time, often expressed as beats per minute (“BPM”).

As used herein, “activity level” means a person's daily physical activity. In one embodiment, activity level includes the corresponding energy expenditure.

As used herein, “blood pressure” means the pressure exerted by circulating blood upon the walls of blood vessels. The term “blood pressure” usually refers to the arterial pressure of the systemic circulation. During each heartbeat, blood pressure varies between a maximum (systolic) and a minimum (diastolic) pressure. Blood pressure can be measured, for example, with a conventional sphygmomanometer.

As used herein, “sleep quality” means the restfulness associated with a person's physical and mental state after waking. “Sleep quality” data includes information about the amount of sleep per stage (e.g., REM), physical movement during sleep, heart rate, breathing rate, etc.

As used herein, “sleep duration” means a person's elapsed (or total) time spent asleep during a particular period of time.

As used herein “hormone levels” means the amount of hormones in the body. Hormones are a class of regulatory biochemicals produced in particular parts of organisms by specific cells, glands, and/or tissues and then transported by the bloodstream to other parts of the body, with the intent of influencing a variety of physiological and behavioral activities, such as the processes of digestion, metabolism, growth, reproduction, and mood control.

In one embodiment of the method, the List of Available Wellness Options consists of a List of Available Food.

As used herein, the term “Meal Ingredients” means component items that comprise a meal. In contrast to fully prepared meals, Meal Ingredients often refer to the list of individual Food components used to prepare a complete meal. Such lists can be found in cookbooks or recipes.

In one embodiment, the method comprises Delivering Food to the user.

### Disclosed Herein is a Personal Wellness System Comprising:

a Database of Personal Information;

a Database of Food Services;

a means for realtime updating the Database of Personal Information and

### Database of Food Services;

a means for selecting sets of wellness opportunities;

a means for communicating wellness opportunities to the person.

As used herein, the term “Database of Food Services” means a stored, organized collection of options for providing Food. In one embodiment, the Database of Food Services is organized as a comma-separated-variable (“CSV”) file, cataloging available Food Services by criteria such as name, zip code, business hours, cuisine, price range, etc.

As used herein, the term “real-time updating” means immediate feedback regarding the state of a specific target. For example, “real-time updating the Database of Personal information and Database of Food Services” includes delivering immediate feedback to the set of acquired and accumulated data regarding the information pertaining to a specific person.

As used herein, the term “wellness opportunities” means potential actions that could be taken by a person pursuant to the person's heath and wellness goals or needs. In one embodiment, a “wellness opportunity” includes consuming a particular Food. In another embodiment, a “wellness opportunity” means pursuing or engaging in a particular activity, such as meditating, breathing exercises, physical exercise, sleeping, or the like. In another embodiment, the term wellness opportunity includes taking a supplement or drug.

As used herein, “sets of wellness opportunities” means a collections or compilations of wellness opportunities.

As used herein, the term “means for selecting sets of wellness opportunities” means a pre-defined logic, algorithm, or logic for choosing a subset of wellness opportunities from within a larger set of wellness opportunities.

As used herein, the term “communicating” means transferring information from one entity to two or more other entities. Accordingly, the term “communicating wellness opportunities to the person” means transferring information about one or more wellness opportunities to a receiving person. In one embodiment, “communicating wellness opportunities to the person” means sending a list of available Food or activities to a person by way of electronic communication, such as text message, email, a webpage, a mobile application or a wearable or implantable device that is connected to a network, such as the internet, and can be viewed.

In one embodiment, the personal wellness system comprises receiving delivery fulfillment instructions from the person.

As used herein, the term “delivery fulfillment instructions” means directions carrying out receiving, processing and delivering of orders set by the customer. The term “receiving delivery fulfillment instructions from the person” means instructions relating to providing physical Food to the person.

In one embodiment, the personal wellness system comprises delivering Food to the person.

As used herein “delivering Food to the person” means bringing food items to the physical location of the person for their acquisition and transferring possession of the Food to the person.

In one embodiment, the disclosed personal wellness system comprises collecting real-time geographic information about the person.

The term “real-time geographic information” means geographic information collected within a period of time chosen from the past minute, the past 10 minutes, the past 30 minutes, the past 90 minutes, or the past 3 hours.

The term “collecting real-time geographic information about the person” means taking and accumulating the positional coordinates (aka location) of the user. In one embodiment, “collecting real-time geographic information about the person” may be accomplished by using GPS or other tracking method to find and store the location of the person.

In one embodiment, the personal wellness system comprises selecting wellness logic.

As used herein, the term “wellness logic” means the use of valid inductive or deductive reasoning to arrive at a particular result. In one embodiment, the wellness logic is chosen from (a) specific logic defined by the person, (b) logic inferred from the person's goal or Goals, or (c) logic implied by human nature (i.e., to feel happiness, physically and mentally capable, etc.).

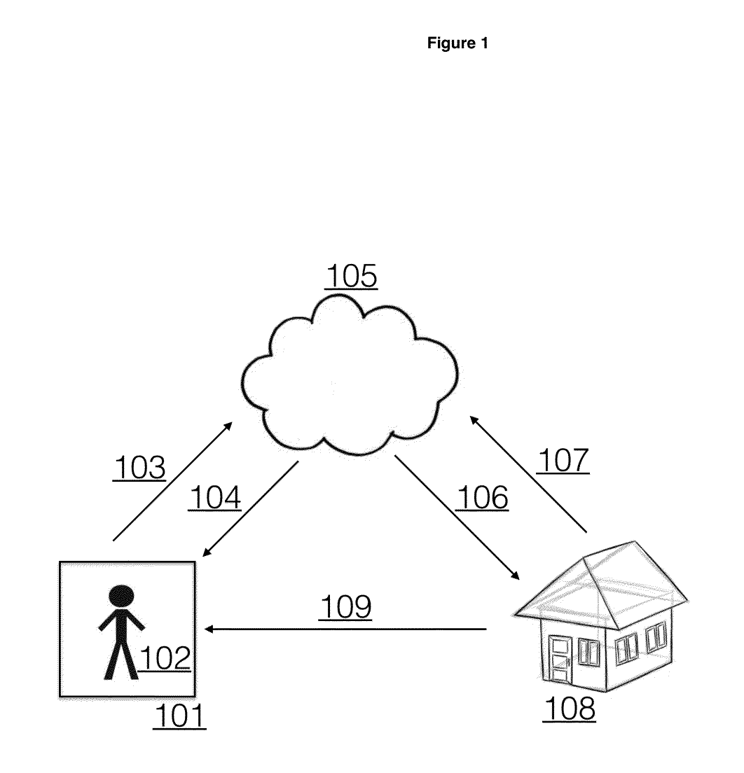

FIGS. 1, 2, and 3 illustrate several features the above-described processes, systems and methods.

FIG. 1, shows a person (102) within a particular geographic location (101). The person conveys Personal Information (103) to a computer (105). The computer stores the Personal Information. The computer acquires (107) information about wellness opportunities (108). Based on system logic, the computer communicates (104) wellness opportunities to the person. Based on the person's input, the computer provides fulfillment instructions (106) to the wellness opportunity. FIG. 1 shows physical delivery (109) of the wellness opportunity.

In the case of meal or food fulfillment, FIG. 1 would apply as follows: the person (102) provides Goals, Preferences, and Requirements (103) to the computer (105). The computer collects and compiles available food by receiving this information from all food service providers publishing this information (107). The computer collects the person's location data (101). The computer applies system logic to arrive at recommendations for the user, communicating viable meal options (104) to the person. The person provides input (103), by selecting an option. The computer conveys instructions (106) to the food serve provider (108). The food service provider delivers (109) the food to the person at the person's location (101).

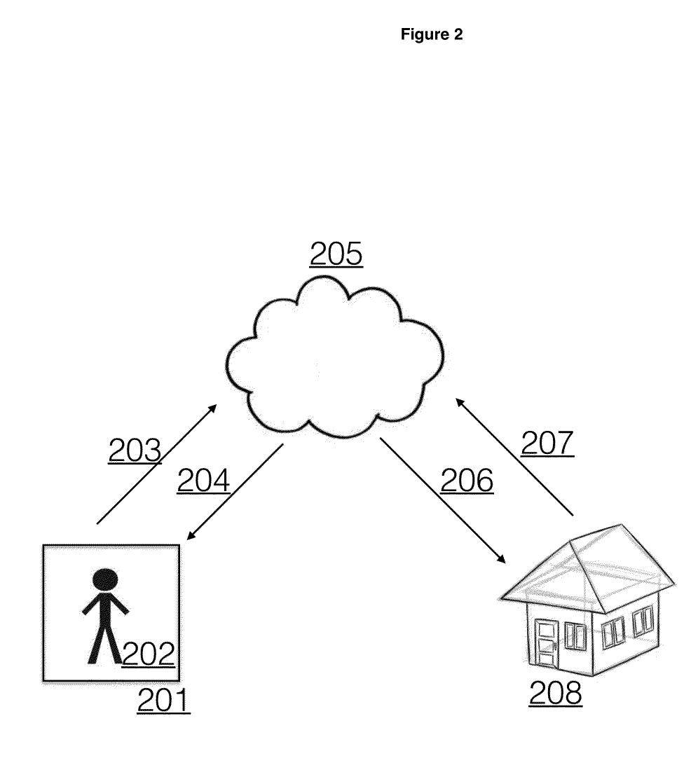

FIG. 2, shows a person (202) within a particular geographic location (201). The person conveys Personal Information (203) to a computer (205). The computer stores the Personal Information. The computer acquires (207) information about wellness opportunities (208). Based on system logic, the computer communicates (204) wellness opportunities to the person. Based on the person's input, the computer provides fulfillment instructions (206) to the wellness opportunity.

In the case of meal delivery, FIG. 2 would apply as follows: the person (202) provides Goals, Preferences, and Requirements (203) to the computer (205). The computer collects and compiles available food by receiving this information from all food service providers publishing this information (207). The computer collects the person's location data (201). The computer applies system logic to arrive at recommendations for the user, delivering a presentation of viable meal options (104) to the person. The person may provide additional input (203), by selecting an option. Where the person selects and option, the computer conveys instructions (206) to the food serve provider (108).

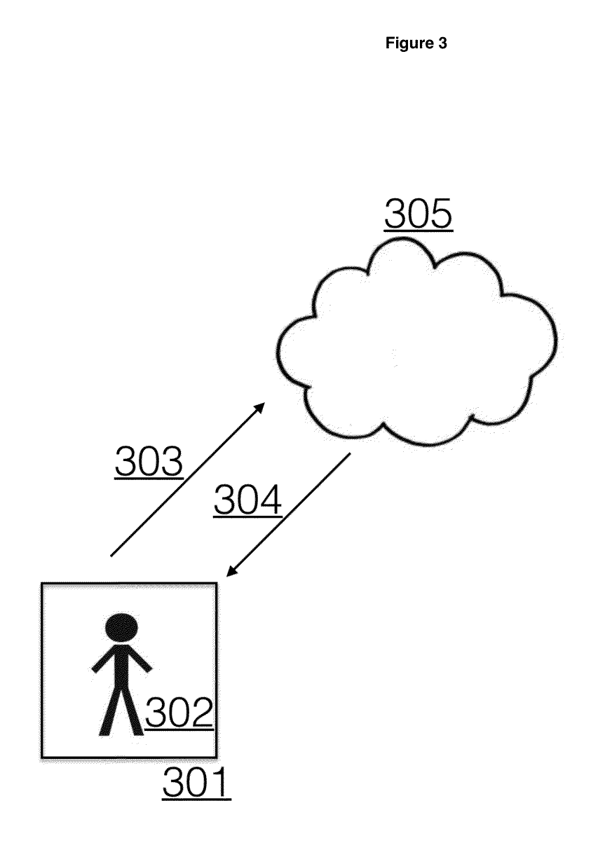

FIG. 3 illustrates a Personal Wellness System of the invention having a person (302) at a location (301). The person conveys Preferences, Goals, and Requirements (303) to the computer (305), which comprises a Global Database of Wellness Options. The computer applies system logic to arrive at recommendations for the person, which the computer then presents (304) to the person.

### EXAMPLES

The following examples are intended highlight several embodiments of the invention. These examples are intended to be illustrative but not limiting.

### Example 1

In one example of the process for providing a person (“Person”) with Food, Person inputs Geographic Location, recurring schedule (e.g., lunch every Monday at 12:00 pm), specifies preference for opt-in meal selection, and preference for delivery to Geographic Location.

The Personal Wellness System identifies which Food providers are able to make physical delivery of Food to Geographic Location; amongst these Food providers, the system identifies which are able to make physical delivery of Food on Monday at 12:00 pm; amongst these Food providers, system identifies which Food items are available on Monday at 12:00 pm, and tags these as Viable Food Items.

The personal Wellness System presents Person with Viable Food Items, based on Person's Input.

Person then selects his or her desired Food item.

The Personal Wellness System then places the order with Food provider, for delivery to Person.

The Food provider delivers the food to Person.

### Example 2

In one example, Person inputs Geographic Location, recurring schedule (e.g., lunch every Monday at 12:00 pm), specifies preference Vegan meals, preference for opt-out meal selection, and preference for delivery to Geographic Location.

The Personal Wellness System applies System Logic to identify which Food providers are able to make physical delivery of Food to Geographic Location; amongst these Food providers, the Personal Wellness System identifies which are able to make physical delivery of Food on Monday at 12:00 pm; amongst these Food providers, system identifies which Food items are available on Monday at 12:00 pm; System identifies which meals are Vegan (based on predetermined System rules/definition for a Vegan meal, based on meal ingredients and their characteristics, preparation method, etc.), and results in a list of Viable Food Items.

The Personal Wellness System recognizes Persons's predefined instructions for opt-out (automatic meal ordering & delivery), then places an order with the Food provider, for delivery to Person. In one variation of this Example, the selected Food item may be randomly selected, or based on a user-defined logic (such as, cuisine variety, historical meal feedback from Person, etc.).

### Example 3

In one example of the Personal Wellness System, Person provides Geographic Location via a mobile device's automatic GPS connectivity, specifies preference for Paleo Diet, specifies preference for a $15 budget, specifies a requirement that Food does not contain the allergen of gluten, and specifies preference for immediate “pick up” Food from Food Provider.

In this example, the Personal Wellness System Applies System Logic to identify which Food providers are within a reasonable geographic radius of Person (i.e., within 1 mile in an urban scenario, with an expanding radius if too few Food providers are available); which Food items are available for immediate pickup; which Food items are considered by the system to be of the Paleo Diet (based on predetermined System rules/definition for a Paleo Diet, based on meal ingredients and their characteristics, preparation method, etc.); which Food items are at or below Person's $15 budget; and which Food items do not contain the allergen of gluten, or can be modified to eliminate gluten.

The Personal Wellness System presents Person with Viable Food Options, based on the Person's inputted preferences and requirements. These Viable Food Options may be presented individually, as a text list, as a photo matrix, or other format, and may be sorted based on geographic distance from Person, price, percentage match to Person's Input, or other criteria.
The Person then selects the desired Food item.

The order is placed with Food provider, for Person to pick up at the location of the Food Service Provider.

### Example 4

In one example of the Personal Wellness System, Person uses Quantified Self Tracking Device to record activity type, duration and intensity of the activity; respiration; heart rate; perspiration and blood mineral levels. Person instructs the Tracking Device with System, to transmit data at regular intervals. In this example, the Person also specifies a Goal of losing weight, from 180 pounds to 160 pounds, within four weeks.

Based on Tracking Device's data feed, the Personal Wellness System determines that person engaged in intense physical exercise, and has discontinued exercise for 10 minutes. The Personal Wellness System also acquires information, from Tracking Device's data feed, that Person has perspired 0.5 liter of sweat, has moderately low sodium levels and has expended 800 kilocalories. In this example, the Personal Wellness System identifies the following: Food providers within a reasonable radius of Person, that will be open for business for at least the next [estimated time to commute to Food provider] minutes; Food items that will provide approximately the Target number of calories (Target calories based on calculation of necessary caloric deficit to reach 160 pound Goal weight, within four weeks, and considers factors such as resting metabolic rate, estimate of additional calories burned, day's calories consumed, current weight, Goal weight, days until Goal date, macronutrient type, etc.); and Food items that will provide necessary levels of sodium.

In this example, the Personal Wellness System notifies Person via Tracking Device or other mobile device of the immediate need to consume 0.5 liters of water and 100 mg of sodium, and also suggests that Person consume a meal for muscle recovery. The Personal Wellness System presents Person with Viable Food Options.

Upon receiving the Viable Food Options, Person confirms consumption of 0.5 liters of water and selects Food item to be ordered for pick up.

The Personal Wellness System places an order for the chosen Food with Food provider, for Person to pick up.

### Example 5

In one example of the Personal Wellness System, Person inputs consumption of alcohol, during the prior evening at 10 pm. Person enables system to track sleep duration and quality, through a mobile device or Quantified Self Tracking Device. Person notifies the Personal Wellness System of a high carbohydrate meal that was consumed at 1 pm, independent from System advice. Person notifies System, via a mobile device or computer, that Person is feeling tired, on the given day, at 2:00 pm.

The Personal Wellness System recognizes that Person consumed alcohol the prior evening. The System notes from sleep tracking, that Person had 6 hours of restless sleep, and did not achieve Stage 4 sleep or REM sleep. The System notes that Person consumed a high carbohydrate meal, with high glucose, one hour prior. The System references its Knowledge Base, which correlates nighttime alcohol with poor sleep and with tiredness; poor sleep with tiredness; and high glycemic load meals with tiredness.

The Personal Wellness System makes a short-term suggestion to Person, sending the message “If you are not caffeine sensitive, it is OK to have a small cup of coffee (less than 8 oz) within 30 minutes, for an energy boost,” and, “If you are able to take a nap or meditate, it is suggested that you do so for 20 to 30 minutes.” The System highlights correlations to Person, such as “It is possible that you are tired right now as a result of any or all of the following factors: late night alcohol consumption, which leads to poor sleep quality; inadequate sleep duration; and consuming a high carbohydrate meal.” System makes long-term suggestion(s) to Person, i.e., “If you regularly have trouble staying asleep, you may want to consider ordering these Food items (dietary supplements): Melatonin, Magnesium, GABA, and L-Glycine,” and “You may want to consume a meal containing L-Tryptophan in the evening, which has been shown to help with sleep.”

At this point in this example, Person can select which factor(s) they feel have contributed to tiredness, which allows the System to improve future recommendations to Person. Person can select a Food item, e.g., Magnesium. Person can agree to the addition of another meal subscription within System. After adequate data is collected by the Personal Wellness System, it draws statistical correlations between the Person's Inputs, also providing confidence intervals, for the sake of the person's better understanding of how they react to environmental factors (Food intake, sleep, exposure to sunlight, time of day for exercise, amount of protein consumption, etc.). Based on Person's selection of Magnesium, such Food item is ordered on behalf of Person from Food provider, and delivered to Person's geographic address of record. Based on Person's selection of an L-Tryptophan containing meal subscription, System identifies appropriate Food items and places orders for such, at appropriate times, with Food provider.

### Example 6

In one example of the Personal Wellness System, Person inputs genetic information, from 3rd party genetic testing service. Person specifies Goal of increased mental and physical performance. Person inputs geographic location. In this example of the Personal Wellness System, the System identifies well-researched, and/or high priority wellness issues related to Person's genetic information. The System identifies homogenous mutation in Person's MTHFR c677t gene. System's knowledge base specifies that individual has difficulty with detoxifying self, and would likely benefit from avoidance of folic acid, heavy metals and chemicals. System's knowledge base specifies that individual would likely benefit from supplementation with specific Food items, such as methyl-cobalamin, P-5-P and folate.

Based on the above, the System makes suggestions to Person, which are integrated into System's rules for Person. For example, System suggests that Person adds rules to “Avoid folic acid-containing foods,” and “Prefer pesticide-free, organic foods, when available”. System also suggests that Person try Food items, methyl-cobalamin, P-5-P and folate, under doctor's care.
Using a mobile device, computer or other means of input, the Person accepts both suggestions from System. Person selects Food item (supplement) suggestion.

Upon receiving Person's input, the System adds two new rules to Person's Profile; System places order for Food item(s) from Food provider, for delivery to Person's geographic address of record.

### Example 7

In one example of the Personal Wellness System, Person inputs that they are currently Type II diabetic. Person inputs that their familial history includes obesity. Person inputs their typical physical activity levels, age, gender and geographic location.

The System adds rules for Person that all meals suggested to Person must contain less than a specific number of carbohydrates, and/or sugars, and/or glycemic load (based on Diabetes input). System adds rules for Person that meals should be low to moderate calorie level, in consideration of their metabolic rate, activity levels, age and gender. System identifies an important piece of Personal Information lacking: weight.

In this example, Food items suggested to Person will conform to requirements set out in System Logic. System also suggests to Person that Person provides body weight, and updates it periodically, in consideration of a familial history of obesity. System recommends to user purchasing a cloud-enabled scale, which is integrated with System, and can automatically keep track of Person's weight.

Person responds to the System Suggestion by agreeing to purchase scale, to assist with Person's weight tracking, which contributes to System's meal recommendations.

In response to Person ordering the scale, the System places and order for the scale for delivery to Person's geographic location. System uses data from scale to make adjustment to Person's meal suggestions, based on factors that may include calorie count, macronutrient breakdown, etc.

### Example 8

In one example of the Personal Wellness System, Person inputs that they have a Goal to try all meals from all Michelin rated restaurants, based on Person's current geographic location. Person's cellular device provides System with Person's geographic location. Person specifies preference for opt-in delivery.

In this example, the Personal Wellness System contains a list of all Michelin-rated restaurants. The System determines which restaurants are within delivery radius of Person. The System contains a list of all Food items available for delivery from these restaurants. The System contains list of meals that Person has already consumed. The System determines which meals are available for delivery from Michelin-rated restaurants, but have not yet been consumed by Person.

The System presents Person with list of Viable Food Items; the System shows which Food items are available, which Food items have already been consumed by Person, and applies Person's Goal for variety to reduce the ranking of already consumed Food items.

After being presented with options, Person selects a Food item.
In response to Person's selection, System places an order for the chosen Food item from the Food provider for delivery to Person's geographic location.

What is claimed is:

1. A computer-implemented process for providing a person with Food comprising:
Acquiring Personal Information about the person;
Determining the Delivery Location for the Food;
Searching a Global Database of Food Providers;
Determining Viable Food Providers;
Assembling a List of Available Food;
Cross-Referencing the List of Available Food with the Personal Information about the person; and
Compiling a List of Viable Food Options.

2. The process of claim 1, comprising delivering Food to the person at the Delivery Location.

3. The process of claim 1, comprising filtering the List of Available Food to select for meals meeting the person's Preferences.

4. The process of claim 1, comprising filtering the List of Available Food to exclude meals failing to meet the person's Requirements.

5. The process of claim 1, comprising filtering the List of Available Food to exclude meals incongruent with the person's Goals.

6. The process of claim 1, comprising acquiring Personal Information about the person less than 3 hours before Compiling the said List of Viable Food Options to the person.

7. The method of claim 2, comprising automatically delivering Food to the person.

8. The process of claim 1, wherein the Food is chosen from plants, animals, beverages, restaurant meals, grocery store items, or nutritional supplements.

9. The process of claim 1, comprising Determining the Delivery Location for the Food by acquiring the person's physical location via GPS data or physical tracking device.

10. The process of claim 1, comprising automatically choosing a specific meal from the List of Viable Food Options.

11. A method of providing realtime health and wellness advice comprising:
Collecting Realtime Physical Data about a specific user;
Compiling List of Available Wellness Options;
Applying Specific User Defined Logic;
Presenting the user with Realtime Viable Wellness Options.

12. The method of claim 11, wherein the Realtime Physical Data is chosen from caloric intake, body temperature, heart rate, activity level, blood pressure, sleep quality, sleep duration, and hormone levels.

13. The method of claim 11, wherein the List of Available Wellness Options consists of a List of Available Food.

14. The method of claim 13, wherein the List of Available Food is chosen from Restaurant Food and Meal Ingredients.

15. The method of claim 14 comprising delivering the Food to the user.

16. A personal wellness system comprising:
a Database of Personal Information;
a Database of Food Services;
a means for realtime updating the Database of Personal Information and Database of Food Services;
a means for selecting sets of wellness opportunities;
a means for communicating wellness opportunities to the person.

17. The system of claim 16, comprising receiving delivery fulfillment instructions from the person.

18. The system of claim 16, comprising delivering Food to the person.

19. The system of claim 16, comprising collecting realtime geographic information about he person.

20. The system of claim 16, wherein the means for selecting wellness logic is chosen from specific logic defined by the person and inferred from the person's goal.
